(19) United States
(12) Patent Application Publication
(10) Pub. No.: US 2007/0137037 A1
(43) Pub. Date: Jun. 21, 2007

(54) Controlled surface modification as an intermediate step in the surface texturing of work rolls

(76) Inventors: Craig A. Noble, Georgetown, PA (US); Rodney Steven Barr, Welland (CA); Dan Zimmerman, Bessemer, AL (US)

Correspondence Address: NORRIS MCLAUGHLIN & MARCUS, P.A., P O BOX 1018, SOMERVILLE, NJ, 08876, US

(21) Appl. No.: 11/311,783

(22) Filed: Dec. 19, 2005

(51) Int. Cl. B21D 53/00; A01B 29/00

(52) U.S. Cl. 29/895; 492/28

(57) ABSTRACT

Apparatus and methods of modifying the surfaces of work rolls and the rolls produced thereby which are used in the manufacture of sheet metals and other sheet materials. The working surface of each roll is processed in a series of process steps which include the step of controlled surface modification as an intermediate step. Other process steps can include texturing such as by means of EDT, EBT, laser texturing, media blasting and chrome coating, among others. Controlled surface modification is carried out at least once as an intermediate process step and it can be carried out additionally at other stages such as at the final stage of the roll surface preparation process. The work rolls produced by the method exhibit improved performance and extended life.

### CROSS-REFERENCE TO RELATED APPLICATIONS

This application is related to two additional applications filed on the same day as this application and having the titles: “WORK ROLLS SURFACE TEXTURED BY MEDIA BLASTING AND CONTROLLED SURFACE MODIFICATION” and “WORK ROLLS HAVING AN ENGINEERED SURFACE TEXTURE PREPARED BY CONTROLLED SURFACE MODIFICATION AFTER CHROME COATING.”

### BACKGROUND OF THE INVENTION

1. Field of the Invention

This invention has to do with apparatus and methods for improving the surface characteristics of work rolls which are used in the manufacture of sheet metals and other sheet products. More specifically, the invention relates to the application of a controlled surface modification process as an intermediate step of the roll surface texturing process. Work rolls processed according to the invention exhibit enhanced mill performance and extended life.

2. The Related Art

In the manufacture of sheet steel, sheet aluminum and other sheet metal products, paper, plastics and other sheet materials, work rolls or cylinders (referred to herein as “rolls”) are employed in the finishing process, for example, in a steel mill, a paper mill or the like. The roll shape and surface are machined to a high degree of accuracy. Traditionally, the roll surface is textured by processes such as electrical discharge texturing (EDT), electron beam texturing (EBT), laser texturing, chemical etching, media blasting such as sand blast, shot blast and shot peen, and the like as well as embossing. In some cases the roll surfaces are then coated by chrome deposition or chrome coating as a final step before the roll is sent to the mill to be used in the manufacture of sheet materials.

The superfinishing process has been applied to roll surfaces following the EDT process in order to improve surface texture as described in published patent application No. 2005/0227594 A1. However, it has not previously been thought necessary to apply superfinishing or other controlled surface modification processes at certain other stages of the roll surface preparation process. We have now discovered that controlled surface modification can be successfully used as an intermediate process step in roll surface preparation with unexpected stability and control that unexpectedly enhances mill performance and extends the usefulness of other methods of texturing previously thought to be outdated.

Media blasting, such as sand blasting, shot blasting and shot peen and the like, is another work roll surface treatment process step that can optionally be used with the present invention to clean or texture the work roll surface. The texture created by media blasting and/or the other process steps described herein helps with grip or bite in the mill and, for example, in the case of sheet steel used in automotive body applications, produces a strip or sheet having a better surface for paint adhesion and appearance as well as better formability properties for deep drawing and stamping.

The process of the invention improves roll life, provides cleaner surfaces and makes it easier to place rolls previously run in a mill back into production. This allows for lower costs associated with less stock removal during subsequent grinding operations and, consequently, extended roll life.

The term “controlled surface modification” is used herein to describe one or a combination of belt grinding, superfinishing, honing, microfinishing, micropolishing and other highly refined and controllable machining processes. The term “chrome coating” is used herein to describe any process for coating chrome on a substrate including the processes of chrome coating or chrome deposition. The term “texturing” is used herein to describe any process used to produce a random surface or pattern of peaks and valleys that is not grinding, such as EDT, laser texturing, media blasting, EBT, chemical etching, embossing and the like.

### SUMMARY OF THE INVENTION

The present invention provides apparatus and methods for applying controlled surface modification to intermediate stages of the roll surface preparation process. An additional step of controlled surface modification can be carried out as the final process step before the roll is placed into service in a mill. As an intermediate step, controlled surface modification is combined with one or more than one additional types of texturing and process steps such as grinding, EDT, EBT, laser texturing, chemical etching, embossing, media blasting, chrome coating and the like. According to the invention, controlled surface modification is carried out at least once as an intermediate step and can be additionally carried out at other stages of the roll surface texturing process.

### BRIEF DESCRIPTION OF THE DRAWINGS

FIG. 1 is a schematic elevational view of a sand blasting or media blasting apparatus for cleaning or texturing the working surface of a work roll.

FIG. 2 is a schematic elevational view of a superfinishing apparatus for modifying the working surface of a work roll.

FIG. 3 is a side view of a superfinishing apparatus in close proximity to a work roll.

FIG. 4 is a top view of the superfinishing apparatus of FIG. 3 in close proximity to a work roll.

### DESCRIPTION OF THE PREFERRED EMBODIMENTS

The rolls prepared according to the present invention are metal rolls that can be made from various ferrous or non-ferrous materials or combinations of both. In practice, the rolls are predominantly made with steel but they may optionally have an outer shell of copper or nickel. They also may be made from cast iron, tool steels, various alloys, titanium, tungsten carbide, combinations thereof and the like.

Chrome coatings are well known in the art and can be carried out using the chrome deposition process or a traditional hard chrome coating bath. The coating thickness of the chrome coating required for particular applications is also well known to those having ordinary skill in the art.

When the optional process step of media blasting is employed, it is preferably performed inside a chamber but it can be performed in an open environment. Compressed air is the preferred means to deliver media to the surface of the roll in a manner which assures uniform coverage of the entire working surface of the roll. For example, the roll may be rotated or moved in some manner and the nozzle discharging the media may be moved. The media can be metallic, non-metallic, ceramic, plastic or chemical or some combination thereof. Some examples of media include sand, sodium bicarbonate, glass beads, aluminum oxide, cast steel shot, angular steel shot, cast steel grit and others. The term media blasting is used generically in this specification to include sand blasting, shot blasting, shot peen and the various methods and media referenced above and other methods and media known in the art.

Electrical discharge texturing (EDT) also referred to as spark electroerosion or electroblast texturing is a known process for texturing the working surface of a roll. The process involves the computer controlled spark erosion of the roll surface. Either the roll is partially or completely immersed in dielectric fluid or the electrodes are dammed off and covered with dielectric fluid or the end of the electrodes are flooded with dielectric fluid near the roll and controlled electrical current is generated and discharged through the dielectric fluid producing ionic charges or sparks of either positive or negative polarity which contact the roll surface. This charge melts the extreme outer layer of the roll, forming microscopic craters proportional in size and spacing to the energy supplied and frequency of generation. The result is an extremely precise, predictable and controllable texture on the roll surface.

The use of electron beam texturing (EBT), laser texturing and chemical etching and embossing are also known to those having skill in the art.

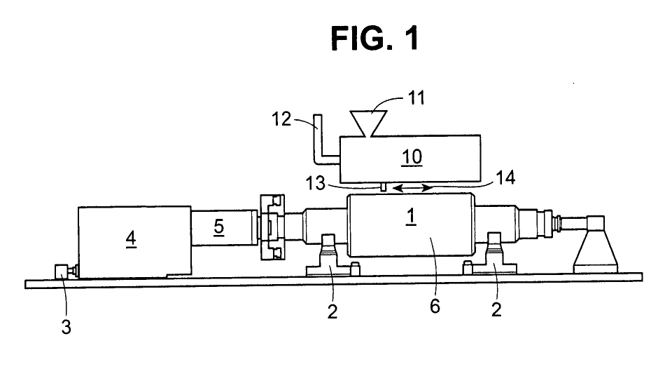

Referring to FIG. 1, roll 1 is rotatably mounted on journal bearing mounts 2. Rotation is controlled by drive motor 3 through gear box 4 and driver 5. Sand blaster 10 is provided with a hopper 11 for receiving media, inlet pipe 12 for compressed air input and nozzle 13 which can be controllably moved laterally in the directions of arrow 14. During the media blasting process step, roll 1 is rotated either clockwise or counter-clockwise and media is blasted with compressed air through nozzle 13 as the nozzle laterally traverses the working surface 6 of roll 1. Rotation of the roll 1 and lateral traversal by the nozzle 13 are controlled in coordination to obtain a uniform texture over the entire working surface 6 of the roll 1.

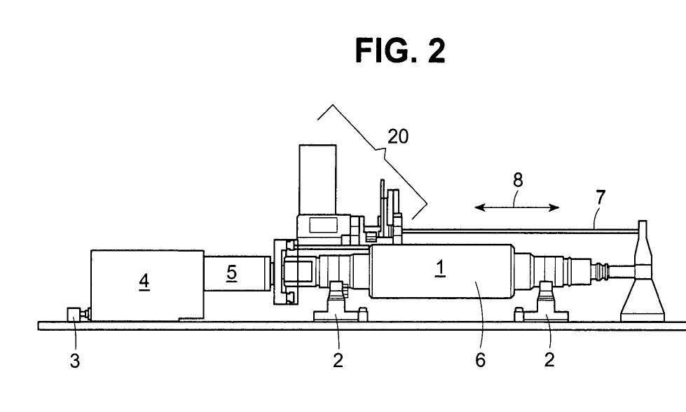

FIG. 2 illustrates a superfinisher 20 mounted in close proximity to roll 1. The superfinisher 20 laterally traverses the working surface 6 of roll 1 along guide rods 7 (one shown) in the directions of arrow 8.

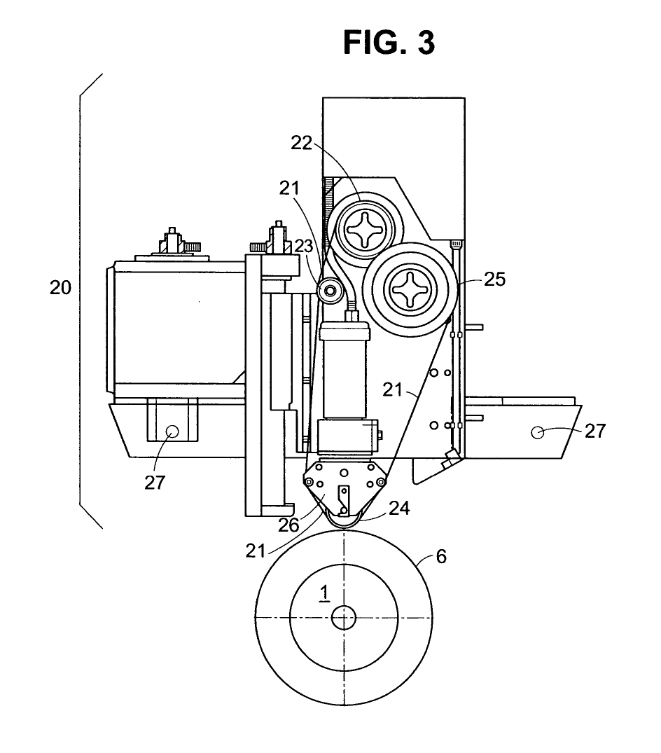

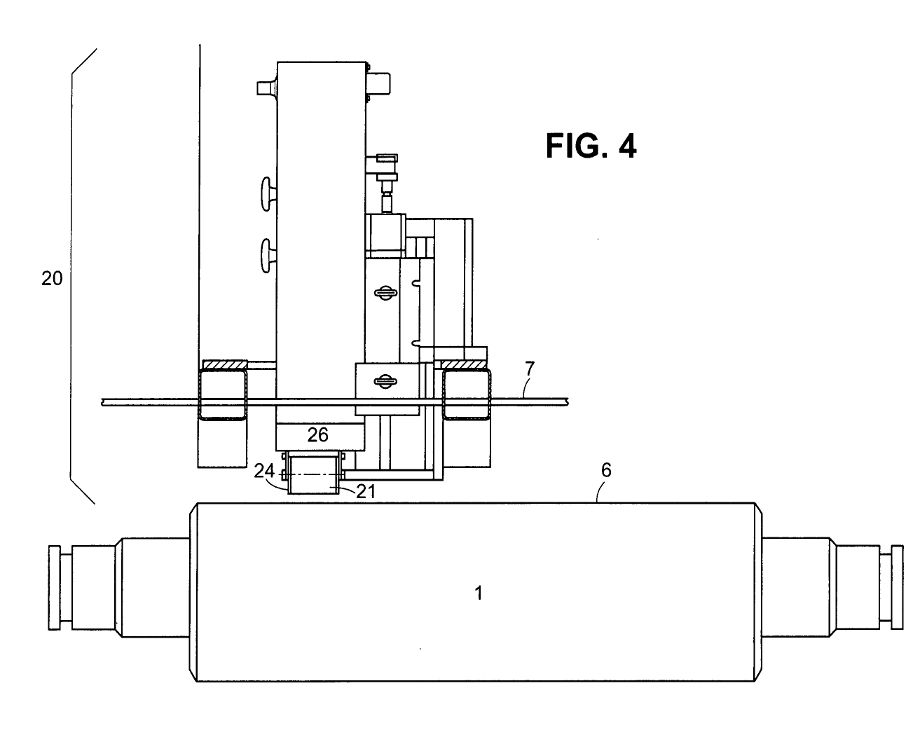

The superfinishing apparatus 20 of the present invention is a type of continuous indexing belt finisher wherein fresh belt is continuously supplied to the surface being finished/ground/machined. The finishing belt, which comes in various grit sizes and configurations such as 9 μm to 100 μm Finishing Film or 2 μm to 30 μm Lapping Film, usually has a width from about 4 to 8 inches and a length from about 10 to about 60 yards and it is wound on a feed reel. As shown in FIG. 3, the belt 21 is fed from feed reel 22 to a guide roller 23, a contact roller 24 and then to a take up reel 25. The contact roller 24 is rotatably affixed to a spring loaded arm 26 which allows the contact roller 24 to apply a contact pressure to the belt 21 and thereby to the working surface 6 of the roll 1. Accordingly, when the superfinisher 20 is processing the working surface 6, the belt 21 is pressed against working surface 6 by contact roller 24. The belt 21 moves continuously so that a fresh unused belt surface can be continuously applied to the working surface 6 of roll 1. Guide holes 27 receive guide rods 7 (see FIGS. 2 and 4) which facilitate lateral controlled movement of the superfinisher 20 along the working surface 6 of the roll 1. The finishing belt can optionally be oscillated during some or all of the controlled surface modification process steps to produce the desired surface characteristics.

A suitable superfinishing apparatus is the Loser Model SF 100 available from Waldemar Loser KG Machinenfabrik, Postfach 1609, Boschstrasse 5, D67346 Speyer, Germany, or a GEM 04150-M or 08150-C Superfinisher available from Grinding Equipment & Machinery Co., Inc., Box 2747, Youngstown, Ohio 44507 USA. Other equipment that can be used for controlled surface modification according to the present invention includes microfinishing systems and machines available from Industrial Metal Products Corporation, 3417 West St. Joseph Street, P.O. Box 10156, Lansing, Mich. 48901 USA or 3M Microfinishing Systems, Building 251-2A-08, 3M Center, St. Paul, Minn. 55144-1000 USA. Another example of suitable equipment is the centerless cylindrical finishing system available from Rand-Bright, 2900 S. 166^{th} Street, New Berlin, Wis. 53151 USA or Supfina Maschinenfabrik Hertzen GmbH & Co. KG, Posffach 100854, Greulingstrasse 33, D-5630 Remscheid, Germany.

FIG. 4 is a top view of FIG. 3.

The process of the present invention modifies the surface texture, characterized by various parameters as Ra, Rp, Pc, Rpk, Rpk*, Rvk, Rz, Rt, Rmax, tₚ, Rsk, etc, measured in micro-inches in the English system or micrometers in the metric system, that was present prior to the start of the controlled surface modification. The surface texture can be modified and tailored as required for optimal performance in different applications.

In addition to controlled surface modification as an intermediate process step, the working surface of the roll is subjected to other processes in order to achieve the desired texture. For example, the working surface of a roll can be processed in various combinations of sequential steps as follows usually but not always after an initial grinding operation to produce a roll having the desired shape:

1. Texturing, controlled surface modification, media blasting and then chrome coating;

2. Texturing, chrome coating, controlled surface modification and then media blasting;

3. Texturing, controlled surface modification, chrome coating and then media blasting;

4. Media blasting, controlled surface modification, chrome coating, run in the mill and then media blasting;

5. Controlled surface modification, texturing, controlled surface modification and then chrome coating;

6. Controlled surface modification, texturing, controlled surface modification, media blasting and then chrome coating;

7. Controlled surface modification, texturing, chrome coating, controlled surface modification and then media blasting;

8. Controlled surface modification, texturing, controlled surface modification, chrome coating then media blasting;

9. Embossing, controlled surface modification, chrome coating, run in the mill and then controlled surface modification;

10. Embossing, controlled surface modification, chrome coating, run in the mill and then media blasting;

11. Embossing, controlled surface modification, texturing, controlled surface modification and then chrome coating;

12. Embossing, controlled surface modification, texturing, controlled surface modification, media blasting, chrome coating;

13. Embossing, controlled surface modification, texturing, chrome coating and then controlled surface modification;

14. Embossing, controlled surface modification, texturing, chrome coating, controlled surface modification and then media blasting;

15. Embossing, controlled surface modification, texturing, controlled surface modification, chrome coating and then media blasting;

16. Texturing, controlled surface modification and then media blasting;

17. Media blasting, controlled surface modification and then media blasting;

18. Embossing, controlled surface modification and then media blasting.

The foregoing lists only a few examples of the combinations of processing sequences that can be used according to the invention. The invention can be carried out using the controlled surface modification in any intermediate step and it can be used once or more than once. Texturing or controlled surface modification can be the final texturing step before the roll is sent to the mill or the first step when it is returned from the mill for reprocessing. Texturing or controlled surface modification can precede chrome coating or one or both of texturing or controlled surface modification can be carried out following chrome coating.

In some cases, a roll surface may be textured or controlled surface modified, or both, to clean it or texture it after it has been used (run) in a mill.

What is claimed is:

1. A method of texturing a work roll having a cylindrical outer surface comprising controlled surface modification of the surface as an intermediate process step.

2. The method of claim 1 wherein a first process step of grinding is carried out prior to controlled surface modification.

3. The method of claim 1 wherein controlled surface modification is carried out prior to or following media blasting.

4. The method of claim 1 wherein controlled surface modification is carried out in two or more than two distinct processing steps.

5. The method of claim 4 wherein a controlled surface modification processing step is the final step of processing the surface of the work roll before it is placed into service in a mill.

6. The method of claim 1 wherein media blasting is carried out in two or more distinct processing steps and at least one media blasting step follows controlled surface modification.

7. The method of claim 1 wherein media blasting is the final step of texturing the work roll before it is placed into service in a mill.

8. A method of modifying a work roll surface, the work roll having a cylindrical outer surface, comprising producing a roll having a desired shape, controlled surface modification of the surface and a final step of finish texturing or cleaning.

9. The method of claim 8 wherein the final step is media blasting.

10. A work roll having a cylindrical outer surface which surface has been modified by a method comprising controlled surface modification of the surface as an intermediate process step.
